(19) United States
(12) Patent Application Publication
(10) Pub. No.: US 2018/0249031 A1
(43) Pub. Date: Aug. 30, 2018

(54) IMAGE PROCESSING APPARATUS AND IMAGE PROCESSING METHOD

(71) Applicants: KABUSHIKI KAISHA TOSHIBA, Tokyo (JP); TOSHIBA TEC KABUSHIKI KAISHA, Tokyo (JP)

(72) Inventors: Takahiro FUCHIGAMI, Yokosuka (JP); Akihiro Moro, Nagaizumi (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/684,104

(22) Filed: Aug. 23, 2017

(30) Foreign Application Priority Data
Feb. 24, 2017 (JP) 2017-034136

(51) Int. Cl. H04N 1/00; H04N 1/38; H04N 1/387; G03G 15/00

(52) U.S. Cl. CPC H04N 1/00708; H04N 1/38; H04N 1/3878; H04N 1/00779; G03G 15/5095; H04N 1/3872

(57) ABSTRACT

In accordance with an embodiment, an image forming apparatus comprises a reading section, a gradation conversion section and an image processing section. The reading section positioned at a back surface of a sheet which is a reading object is provided with a back surface part having a predetermined color at the back surface side of the sheet to read at least one surface of the sheet by using the back surface part as a background. The gradation conversion section executes a gradation conversion processing of enlarging a level difference in brightness at a highlight side on image data read by the reading section. The image processing section identifies an area of the sheet part and an area of the back surface part in the image data based on the image data to which the gradation conversion processing is executed.

### CROSS-REFERENCE TO RELATED APPLICATION

This application is based upon and claims the benefit of priority from Japanese Patent Application No. 2017-034136, filed Feb. 24, 2017, the entire contents of which are incorporated herein by reference.

### FIELD

Embodiments described herein relate generally to an image forming apparatus and an image processing method.

### BACKGROUND

There is an image forming apparatus capable of reading an irregular sheet such as a voucher or a receipt as an original document which is a reading object. In the reading of such an irregular sheet, first, a range including the whole sheet is read. A sheet part and a part of material (for example, a sheet cover coated on a sheet table) of a sheet back surface are contained in a read image. The irregular sheet is generally read by cutting an image of the sheet part from an image read in this manner.

However, if a color of a material of the sheet back surface is similar to a color of a ground of the sheet, there is a case in which it is difficult to identify contour line of the sheet part and it is impossible to correctly cut the image on the sheet part. The sheet cover is generally comprised by white material which is hard to cover an image at the time of copying, and the ground of the sheet which is the reading object is mostly white. Thus, in the image data acquired by reading, there is a case where it is different to distinguish the white part of the sheet cover and the white part of the sheet ground. Conventionally, although there are some proposals of the image forming apparatus including a component for solving such a problem, in each of those proposals, a member having a distinguishable color from the sheet part is arranged on the sheet back surface. In such an arrangement, a special mechanism which controls addition of the member and a position of the member is necessary, which may lead to an increase in manufacturing cost.

### DESCRIPTION OF THE DRAWINGS

FIG. 1 is an external view exemplifying an image forming apparatus 100 according to a first embodiment;

FIG. 2 is a diagram of an image reading section 3 according to the first embodiment;

FIG. 3 is a diagram of setting information used in a first gradation conversion processing and a second gradation conversion processing according to the first embodiment;

FIG. 4 is a diagram of image data according to the first embodiment;

FIG. 5 is flowchart for determining a division position of first image data by the image reading section 3 according to the first embodiment;

FIG. 6 is a diagram of operators in each direction of a Sobel filter processing according to the first embodiment;

FIG. 7 is a diagram of a processing result of the Sobel filter processing according to the first embodiment;

FIG. 8 is a diagram illustrating a state in which the image data is divided by setting a detected boundary between sheets as a division position according to the first embodiment;

FIG. 9 is a diagram of functional components of an image reading section 3a according to a second embodiment;

FIG. 10 is a diagram f image data obtained by eliminating a highlight side by a gradation conversion processing according to the second embodiment;

FIG. 11 is a flowchart of reading an irregular sheet by the image forming apparatus 100 according to the second embodiment;

FIG. 12 is a diagram exemplifying the operation of a sheet position detection processing according to the second embodiment;

FIG. 13 is a diagram of the sheet position detection processing according to the second embodiment;

FIG. 14 is a flowchart of an image cutting processing according to the second embodiment;

FIG. 15 is a diagram of relationship between a sheet position in front surface image data and a sheet position in back surface image data according to the second embodiment; and

FIG. 16 is a diagram of image data outputted as a reading result according to the second embodiment.

### DETAILED DESCRIPTION

In accordance with an embodiment, an image forming apparatus comprises a reading section, a gradation conversion section and an image processing section. The reading section positioned at a back surface of a sheet which is a reading object is provided with a back surface part having a predetermined color at the back surface side of the sheet to read at least one surface of the sheet by using the back surface part as a background. The gradation conversion section executes a gradation conversion processing of enlarging a level difference in brightness at a highlight side on image data read by the reading section. The image processing section identifies an area of the sheet part and an area of the back surface part in the image data based on the image data to which the gradation conversion processing is executed.

Hereinafter, an image forming apparatus and an image processing method of an embodiment are described with reference to the accompanying drawings.

### First Embodiment

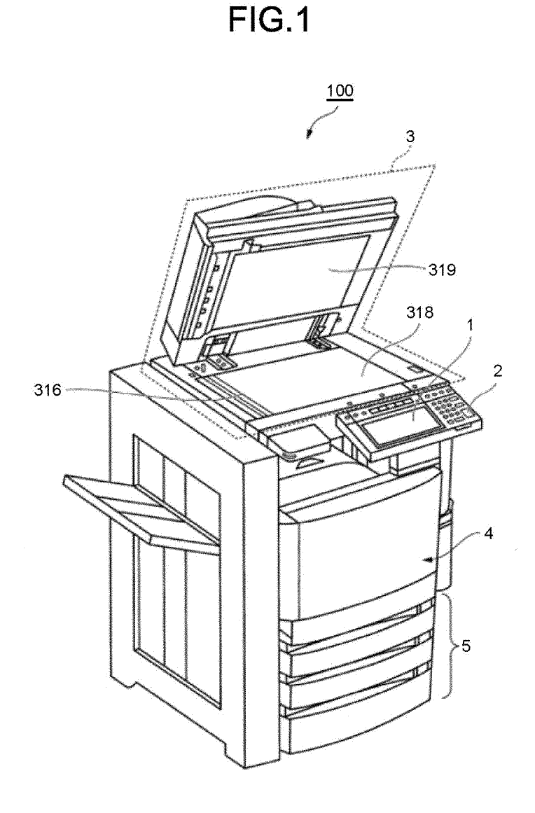

FIG. 1 is an external view exemplifying the whole structure of an image forming apparatus 100 according to the first embodiment. The image forming apparatus 100 is, for example, a multi-function peripheral. The image forming apparatus 100 comprises a display 1, a control panel 2, an image reading section 3, a printer section 4 and a sheet housing section 5. The image forming apparatus 100 forms an image on a sheet using a developing agent such as a toner. The sheet is, for example, a paper or a label paper. The sheet may be an optical object as long as the image forming apparatus 100 can form an image on a surface thereof.

The display 1 is an image display device such as a liquid crystal display, an organic EL (Electro Luminescence) display, or the like. The display 1 displays various information relating to the image forming apparatus 100.

The control panel 2 has a plurality of buttons. The control panel 2 receives an operation by a user. The control panel 2 outputs a signal in response to the operation executed by the user to a controller of the image forming apparatus 100. The display 1 and the control panel 2 may be integrated as a touch panel.

The image reading section 3 reads image information of a sheet which is a reading object as the density of light. The image reading section 3 records the read image information. The recorded image information may be transmitted to another information processing apparatus via a network. The recorded image information may be used to form an image on the sheet by the printer section 4.

Specifically, the image reading section 3 is provided with a scanner unit 316, a glass surface 318 and a cover 319. The sheet which is the reading object is placed on the glass surface 318. The scanner unit 316 is positioned below the glass surface 318 to read an image on the sheet by irradiating light through the glass surface 318. The cover 319 is coated on the glass surface 318 at the time of reading so that the light of the scanner unit does not leak out to the outside. Thus, in this case, a surface (hereafter, referred to as a “cover surface”) of the cover 319 facing the glass surface 318 is read as a background of the sheet. Generally, as the ground of the sheet which is the reading object is mostly white, the cover surface is mostly made of a white member.

The printer section 4 forms an image on the sheet ground on image information generated by the image reading section 3 or image information received via a communication path. The printer section 4 forms an image by the following processing, for example. An image forming section of the printer section 4 forms an electrostatic latent image on a photoconductive drum based on the image information. The image forming section of the printer section 4 forms a visible image by attaching a developing agent to the electrostatic latent image. The toner is exemplified as a specific example of the developing agent. A transfer section of the printer section 4 transfers the visible image onto the sheet. A fixing section of the printer section 4 fixes the visible image on the sheet by heating and pressurizing the sheet. The sheet on which an image is formed may be a sheet housed in the sheet housing section 5 or may be a manually fed sheet.

The sheet housing section 5 houses sheets used for image formation by the printer section 4.

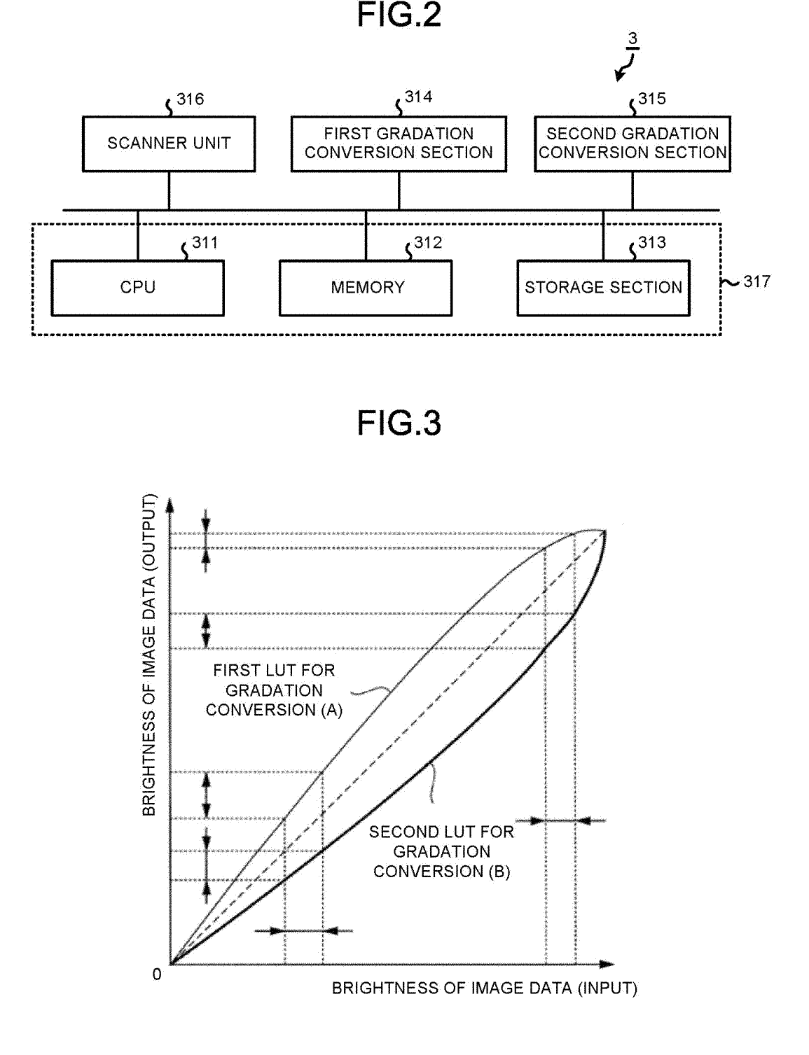

FIG. 2 is a diagram of an image reading section 3 according to the first embodiment. The image reading section 3 comprises a CPU 311 (Central Processing Unit), a memory 312, a storage section 313, a first gradation conversion section 314, a second gradation conversion section 315 and the scanner unit 316 which are connected via a bus line. For example, the CPU 301 functions as a reading controller 317 which controls each functional section of the image reading section 3 by reading a program stored in the storage section 313 into the memory 312 and executing it. All or a part of the functions of the image reading section 3 may be realized by using hardware such as ASIC (Application Specific Integrated Circuit), PLD (Programmable Logic Device), FPGA (Field Programmable Gate Array) or the like. The program may be recorded on a computer-readable recording medium. The computer-readable recording medium is, for example, a portable medium such as a flexible disk, a magneto-optical disk, a ROM, a CD-ROM or the like, or a storage device such as a hard disk built in a computer system. The program may be transmitted via an electric communication line.

The scanner unit 316 reads a sheet placed on the glass surface 318 in response to an instruction from the reading controller 317. The scanner unit 316 outputs the image data of the read sheet. For example, the generated image data is stored in the storage section 313. In the present embodiment, it is assumed that a plurality of sheets placed on the glass surface 318 is read into one image data.

Each of the first gradation conversion section 314 and the second gradation conversion section 315 reads the image data stored in the storage section 313 and outputs the image data subjected to a predetermined gradation conversion processing to the storage section 313. The image data after the gradation conversion processing is stored in a storage area different from the image data before the gradation conversion processing. Hereinafter, a gradation conversion processing executed by the first gradation conversion section 314 is described as a first gradation conversion processing, and a gradation conversion processing executed by the second gradation conversion section 315 is described as a second gradation conversion processing.

The reading controller 317 detects division positions of a plurality of sheets included in the image data based on the image data subjected to the first gradation conversion processing. Specifically, the reading controller 317 detects the boundary between sheets by analyzing a color distribution in the image. The reading controller 317 divides the image data using the detected boundary as the division position and stores the divided image data of each sheet as a reading result in the storage section 313.

FIG. 3 is a diagram of setting information used for the first gradation conversion processing and the second gradation conversion processing in the first embodiment. For example, the setting information is expressed in a form of a lookup table (LUT) that gives a value of output data with respect to a value of input data. A first LUT for gradation conversion (A) is used for the first gradation conversion processing, and a second LUT for gradation conversion (B) is used for the second gradation conversion processing. For example, the setting information is previously stored in the storage section 313.

In FIG. 3, a horizontal axis represents the brightness of the input image data, and a vertical axis represents the brightness of the output image data. In this case, the first LUT for gradation conversion (A) plays a role of reducing a level difference in the brightness of the highlight side (a bright side with larger brightness) and increasing a level difference in the brightness of a shadow side (a dark side with smaller brightness) in the gradation conversion processing. On the other hand, in the gradation conversion processing, the second LUT for gradation conversion (B) plays a role of increasing the level difference in the brightness of the highlight side and reducing the level difference in the brightness of the shadow side. In general, the brightness at the input side is expressed as RGB values having information amount of about 10-14 bits, and the brightness at the output side is represented by RGB values having information of about 8 bits.

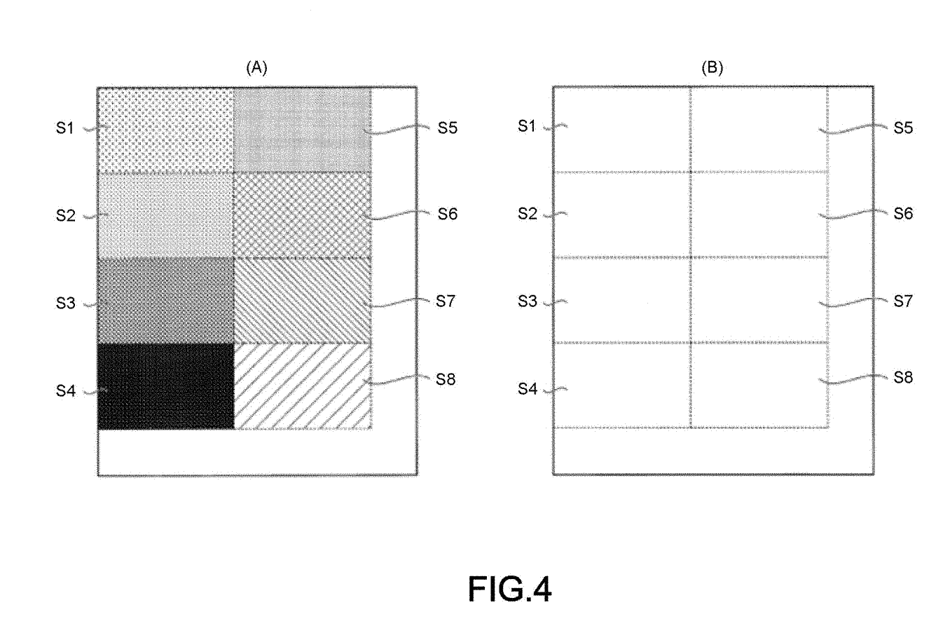

FIG. 4 is a diagram of the image data according to the first embodiment. FIG. 4(A) and FIG. 4(B) are diagrams illustrating results of executing different gradation conversion processing on the same image data. More specifically, FIG. 4(A) shows the image data after the second gradation conversion processing (enlarging the level difference of the highlight side), and FIG. 4(B) shows the image data after the first gradation conversion processing (reducing the level difference of the highlight side). As known from FIG. 4(A), in the image data after the second gradation conversion processing (hereinafter, referred to as “second image data”), gradation differences between sheets S1˜S8 are enlarged and the boundary between the sheets becomes an image which is more easily detectable. On the other hand, as known from FIG. 4(B), in the image data after the first gradation conversion processing (hereinafter, referred to as “first image data”), the gradation differences between the sheets are reduced and white level of each of the sheets S1-S8 is corrected equally.

By executing such gradation conversion processing, the reading controller 317 detects the boundary between sheets based on the second image data, and divides the first image data using the detected boundary as the division position. With such a method, it is possible to generate image data in which white level is unified and which is divided at an appropriate position for each sheet. The first gradation conversion processing may be executed individually for each of the divided image data.

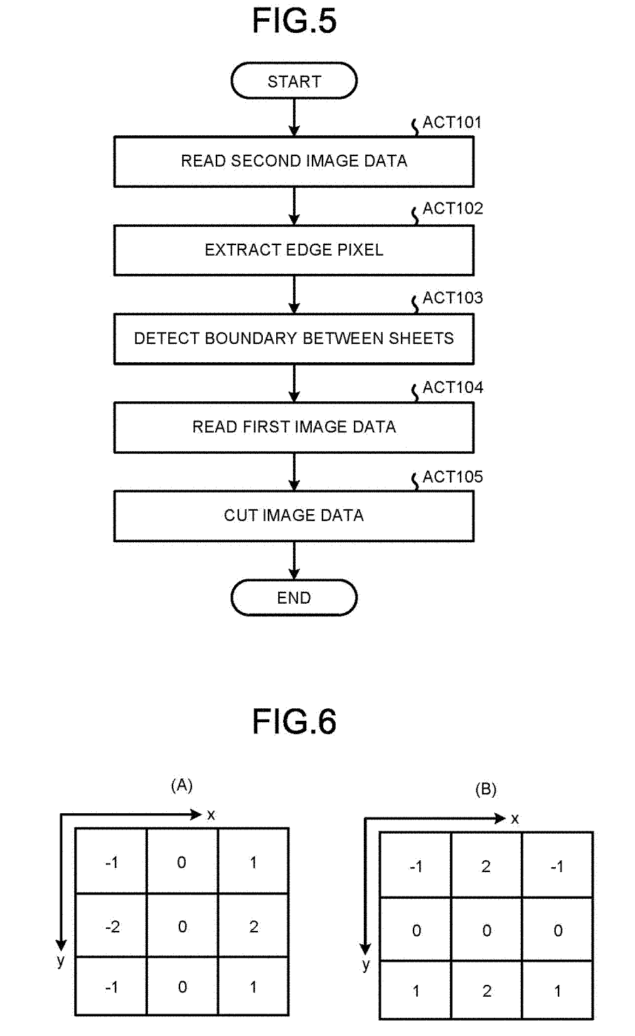

FIG. 5 is a flowchart in which the image reading section 3 determines the division position of the first image data according to the first embodiment. First, the reading controller 317 reads the image data (second image data) subjected to the second gradation conversion processing from the storage section 313 (ACT 101). The reading controller 317 extracts edge pixels by executing a Sobel filter processing described later on the read image data (ACT 102). The reading controller 317 detects the boundary between sheets by counting the extracted edge pixels in each of the vertical and horizontal directions (ACT 103).

Subsequently, the reading controller 317 reads the image data (first image data) subjected to the first gradation conversion processing from the storage section 313 (ACT 104). The reading controller 317 cuts the image data of each sheet from the first image data using the boundary between sheets detected in the ACT 103 as the division position (ACT 105).

FIG. 6 is a diagram of operators in each direction of the Sobel filter processing according to the first embodiment. FIG. 6(A) is a diagram illustrating a specific example of the operator in an X direction, and FIG. 6(B) is a diagram illustrating a specific example of the operator in a Y direction. In the Sobel filter processing using these operators, first of all, absolute values Sx and Sy (an example of scores) of the convolution product-sum operation of the image data and the operator are calculated with a target pixel of the image data as a center position of the operator. In other words, if the target pixel of the image data is expressed as P(x, y), in the Sobel filter processing in the X direction and the Y direction, operation as shown in the following equations (1) and (2) for each direction is performed for each color of RGB.

$$\begin{matrix}Sx ( x , y ) = \vert ( - 1 ) * P ( x - 1 , y - 1 ) + ( 0 ) * P ( x , y - 1 ) + ( 1 ) * P ( x + 1 , y - 1 ) + ( - 2 ) * P ( x - 1 , y ) + ( 0 ) * P ( x , y ) + ( 2 ) * P ( x + 1 , y ) + ( - 1 ) * P ( x - 1 , y + 1 ) + ( 0 ) * P ( x , y + 1 ) + ( 1 ) * P ( x + 1 , y + 1 ) \vert & Equation ( 1 ) \\ Sy ( x , y ) = \vert ( - 1 ) * P ( x - 1 , y - 1 ) + ( - 2 ) * P ( x , y - 1 ) + ( - 1 ) * P ( x + 1 , y - 1 ) + ( 0 ) * P ( x - 1 , y ) + ( 0 ) * P ( x , y ) + ( 0 ) * P ( x + 1 , y ) + ( 1 ) * P ( x - 1 , y + 1 ) + ( 2 ) * P ( x , y + 1 ) + ( 1 ) * P ( x + 1 , y + 1 ) \vert & Equation ( 2 )\end{matrix}$$

However, since the purpose of the Sobel filter processing is to extract the edge pixels of the sheet, in the case where the target pixel is out of the highlight range so that characters or the like in the sheet do not adversely affect the detection of the edge, the operation results of the equations (1) and (2) are forcibly set to 0 (zero).

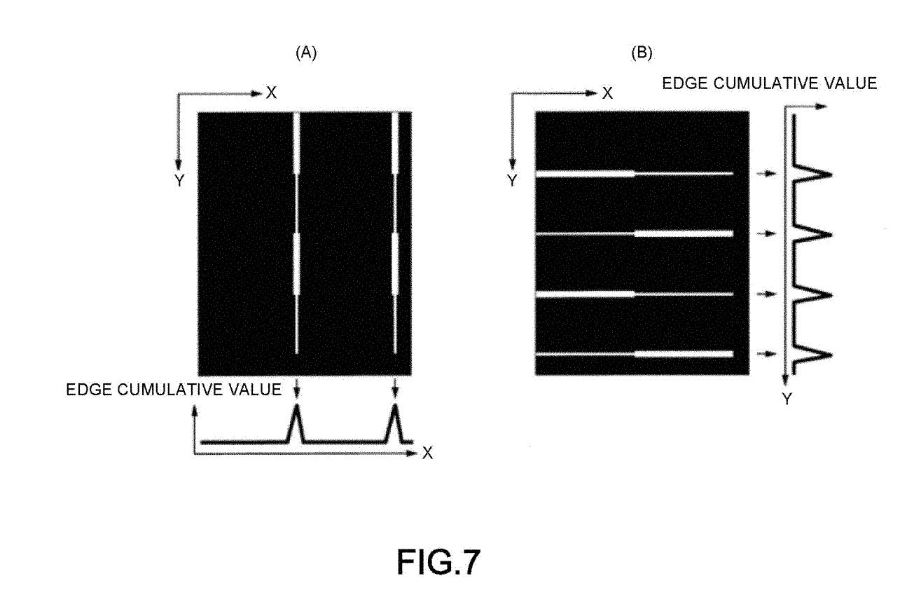

FIG. 7 is a diagram of the processing result of the Sobel filter processing according to the first embodiment. FIG. 7(A) shows the processing result in the X direction and FIG. 7(B) shows the processing result in the Y direction. An image A in FIG. 7(A) shows an absolute value calculated by the operator in the X direction for each pixel as a pixel value, and a graph below shows a cumulative value obtained by accumulating the absolute value of each pixel in the Y direction. Since each pixel value indicated by the image A represents an edge component in the Y direction, by accumulating each pixel value in the Y direction, it is possible to detect the boundary in the X direction between the sheets.

On the other hand, an image Bin FIG. 7(B) shows an absolute value calculated by the operator in the Y direction for each pixel as a pixel value, and a graph at the right shows a cumulative value obtained by accumulating the absolute value of each pixel in the X direction. Since each pixel value indicated by the image B represents an edge component in the X direction, it is possible to detect the boundary in the Y direction between the sheets by accumulating each pixel value in the X direction.

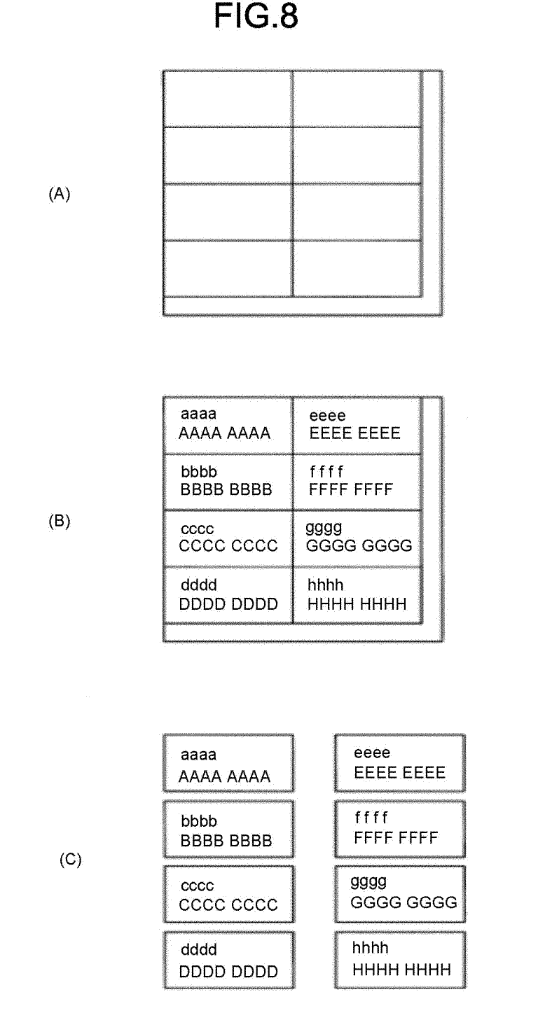

FIG. 8 is a diagram illustrating a state of dividing the boundary between the sheets on which the image data is detected as the division position in the first embodiment. FIG. 8(A) is a diagram illustrating the boundary between the sheets detected through the Sobel filter processing. FIG. 8(B) is a diagram illustrating the image data (first image data) subjected to the first gradation conversion processing, and FIG. 8 (C) is a diagram illustrating the image data divided for each sheet.

The boundary line between the sheets shown in FIG. 8(A) is obtained by integrating the boundaries detected by the Sobel filter processing in the X direction and the Y direction. The reading controller 317 generates the image data for each sheet by dividing the first image data at the boundary between the sheets detected in that manner. The reading controller 317 converts the image data of each sheet generated in this manner into a file, and outputs the individual image data which is converted into the file as the reading result. The reading controller 317 may store the image data of the reading result in the storage section 313.

The image forming apparatus 100 of the first embodiment arranged as described above detects the boundary between the sheets by executing the second gradation conversion processing on one image data obtained by reading a plurality of sheets, and can generate the individual image data for the plurality of sheets by dividing the one image data using the detected boundary as the division position. According to the image forming apparatus 100 of the first embodiment having such an arrangement, it is possible to realize the generation of the image data in which the image data of each sheet part is cut from the image obtained by reading one or more sheets with a simpler arrangement.

In the present embodiment, an example is described in which each sheet is cut from one image data obtained by reading a plurality of sheets arranged on the glass surface 318; however, the number of sheets to be read may be one. Even if the sheet which is the reading object is one, by executing the first gradation conversion processing and the second gradation conversion processing, the sheet part and the cover 319 part in the image data can be distinguished and identified.

### Second Embodiment

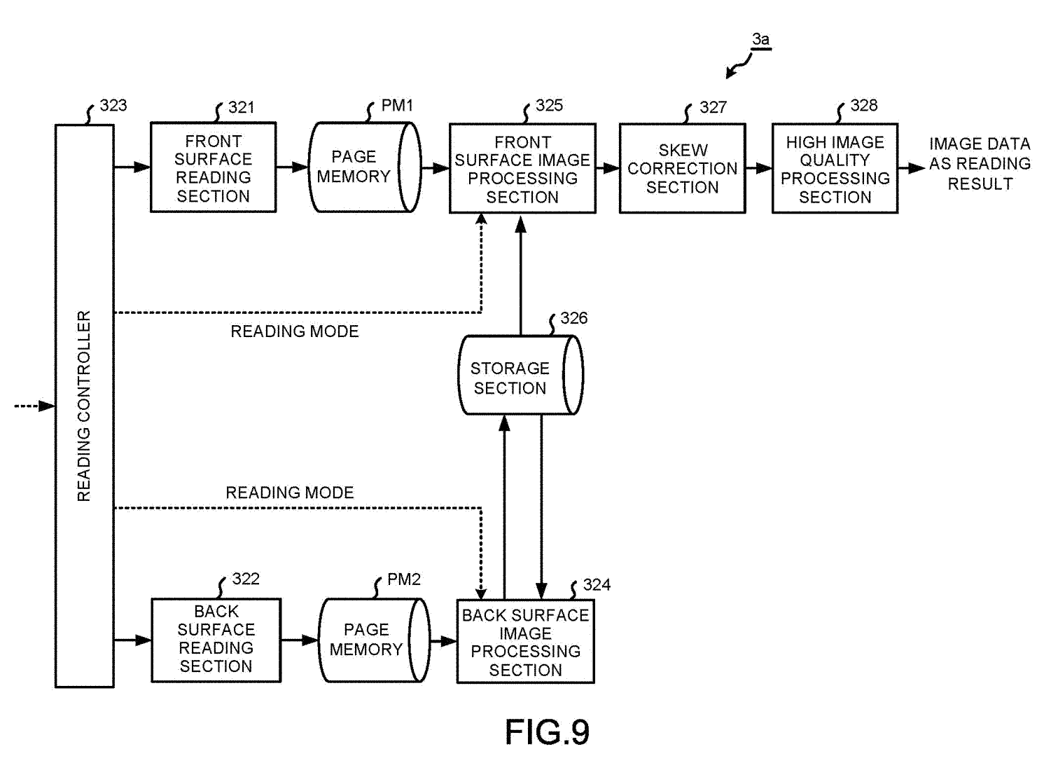

FIG. 9 is a diagram of functional components of the image reading section 3a according to the second embodiment. The image reading section 3a is provided with a front surface reading section 321, a back surface reading section 322, a reading controller 323, a back surface image processing section 324, a front surface image processing section 325, a storage section 326, a skew correction section 327 and a high image quality processing section 328. The image reading section 3a has a function of reading both a front surface and a back surface of the sheet in one reading operation. The front surface reading section 321 reads a front surface of a sheet to generate image data (hereinafter, referred to as “front surface image data”) obtained by reading the front surface of the sheet. Furthermore, both the front surface reading section 321 and the back surface reading section 322 are arranged in such a manner that a member positioned at the back surface of the sheet is white at the time of reading. The front surface reading section 321 outputs the generated front surface image data to the front surface image processing section 325.

The back surface reading section 322 reads the back surface of the sheet to generate image data (hereinafter, referred to as “back surface image data”) obtained by reading the back surface of the sheet. The back surface reading section 322 outputs the generated back surface image data to the back surface image processing section 324. The front surface reading section 321 and the back surface reading section 322 may read the front surface and the back surface of the sheet at different positions on a conveyance path or at the same position on the conveyance path.

The reading controller 323 has a function of controlling an operation of the image reading section 3a according to a reading mode. The reading mode is an image reading operation mode designated for the image forming apparatus 100. For example, the reading mode may include a regular mode for reading a regular sheet and an irregular mode for reading an irregular sheet. The reading mode for the image forming apparatus 100 is designated by a user. For example, the user designates the reading mode for the image forming apparatus 100 by operating the control panel 2. The control panel 2 informs the image reading section 3a of the inputted reading mode.

Specifically, if the reading mode is the irregular mode, the reading controller 323 enables the front surface reading section 321 and the back surface reading section 322 to read both surfaces of the sheet, and enables the back surface image processing section 324 and the front surface image processing section 325 to execute image processing in response to the irregular mode.

The back surface image processing section 324 executes an image processing in response to the reading mode informed from the reading controller 323 on the back surface image data generated by the back surface reading section 322. Specifically, the back surface image processing section 324 carries out an image processing for specifying the sheet position in the image on the back surface image data. The back surface image processing section 324 specifies the sheet position in the image based on the back surface image data on which the image processing is executed and stores information indicating the specified sheet position (hereinafter, referred to as a “back surface position information”) in the storage section 326.

The front surface image processing section 325 executes an image processing in response to the reading mode informed from the reading controller 323 on the front surface image data generated by the front surface reading section 321.

Specifically, the back surface image processing section 324 cuts the image on the sheet front surface from the front surface image data based on the back surface position information generated by the front surface image processing section 325. The front surface image processing section 325 outputs the cut image data of the sheet front surface to the skew correction section 327.

The storage section 326 is comprised by a storage device such as a magnetic hard disk device or a semiconductor storage device. The storage section 326 stores setting information. The setting information indicates settings necessary for the image processing in the back surface image processing section 324 and the front surface image processing section 325. Specifically, the setting information includes information necessary for the gradation conversion processing of the image data. For example, the information necessary for the gradation conversion processing of the image data is stored in a form of the lookup table (LUT) that gives the value of the output data with respect to the value of the input data. Hereinafter, the LUT used as the setting information of the gradation conversion processing is described as LUT for gradation conversion. In the LUT for gradation conversion, different LUTs may be provided depending on property and purpose of the gradation conversion processing. The LUT for gradation conversion in the second embodiment is the same as that in the first embodiment shown in FIG. 3.

The skew correction section 327 executes a skew correction processing for correcting deviation of the inclination of the image with respect to the image data obtained by cutting the image data outputted from the front surface image processing section 325. The skew correction section 327 outputs the image data subjected to the skew correction processing to the high image quality processing section 328.

The high image quality processing section 328 executes a high image quality processing for removing noise, enhancing edges and the like. The high image quality processing section 328 outputs the image data subjected to the high image quality processing as the reading result of the irregular mode.

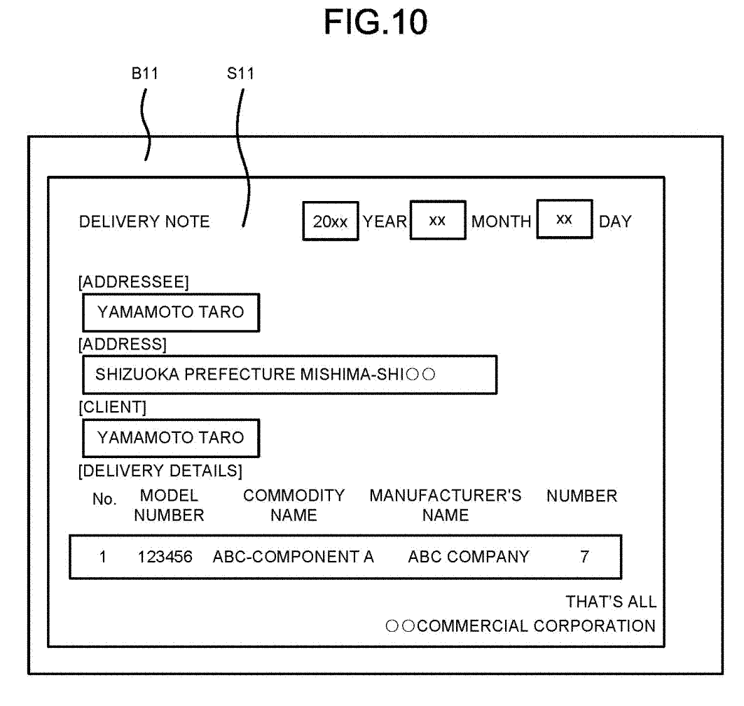

FIG. 10 is a diagram of the image data obtained by eliminating the highlight side by the gradation conversion processing according to the second embodiment. As shown in FIG. 10, in the image data obtained by eliminating the highlight side, the level difference between the white color of the sheet ground part S11 and the white color of the member of the sheet back surface B11 becomes small, making it difficult to distinguish a boundary therebetween. Therefore, it is difficult to accurately cut the image of the sheet part from the image data.

Contrarily, the back surface image processing section 324 executes the gradation conversion processing using the second LUT for gradation conversion (B) on the back surface image data to increase the level difference in the brightness of the highlight side. By executing such a gradation conversion processing, the level difference between the white color of the sheet ground and the white color of the sheet back surface member in the read back surface image is enlarged, and the boundary therebetween becomes clearer. After executing such a gradation conversion processing, the back surface image processing section 324 specifies the sheet position in the image by identifying the boundary between the sheet ground and the sheet back surface member to store the back surface position information indicating the specified sheet position in the storage section 326.

The front surface image processing section 325 cuts the image data of the sheet front surface from the front surface image data based on the back surface position information generated by the back surface image processing section 324. The front surface image processing section 325 outputs the cut image data of the sheet front surface as the reading result. The front surface image processing section 325 may execute the gradation conversion processing using the first LUT for gradation conversion (A) on the front surface image data before cutting or on the cut image data of the sheet front surface.

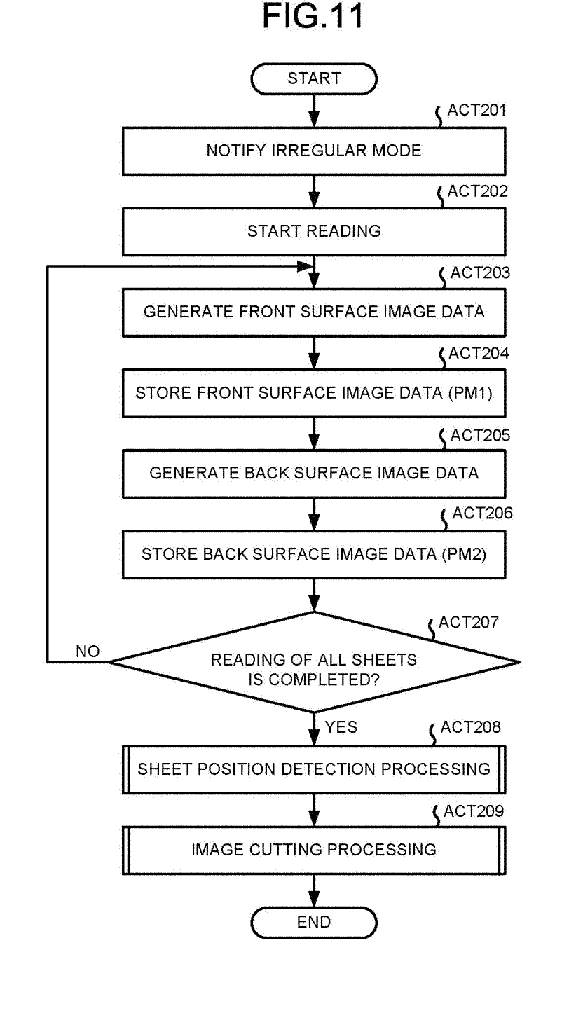

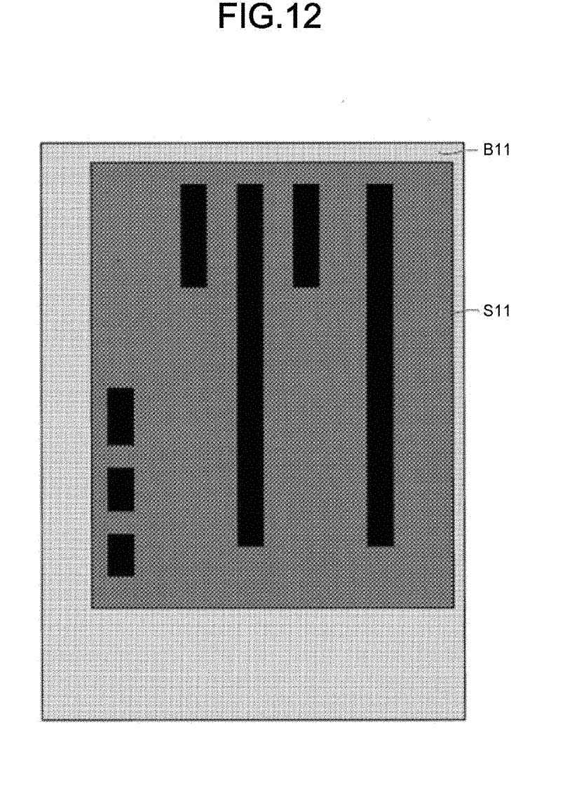

FIG. 11 is a flowchart of reading the irregular sheet by the image forming apparatus 100 according to the second embodiment. First, an instruction to execute the reading in the irregular mode is input to the image forming apparatus 100. For example, the instruction is input by operating the control panel 2 by the user. The control panel 2 informs the reading controller 323 of the image reading section 3a that the input instruction instructs to execute the reading in the irregular mode. The reading controller 323 informs the front surface reading section 321, the back surface reading section 322, the back surface image processing section 324 and the front surface image processing section 325 that the reading mode is the irregular mode (ACT 201).

The front surface reading section 321 and the back surface reading section 322 start reading a sheet in response to the notification of the reading mode (ACT 202). The front surface reading section 321 reads the front surface of the sheet to generate the front surface image data (ACT 203). The front surface reading section 321 stores the generated front surface image data in a page memory (ACT 204). Similarly, the back surface reading section 322 reads the back surface of the sheet to generate the back surface image data (ACT 205). The back surface reading section 322 stores the generated back surface image data in a page memory (ACT 206). The page memories may be separately provided for the front surface and the back surface, or an area for the front surface and an area for the back surface may be provided on one page memory. The front surface image data and the back surface image data are stored in the page memory in association with each read sheet.

The reading controller 323 determines whether the reading of all sheets to be read is completed (ACT 207). If there is a sheet of which the reading is not completed (No in ACT 207), the reading controller 323 returns the processing in ACT 203 and enables the front surface reading section 321 and the back surface reading section 322 to read the next sheet. On the other hand, if the reading of all the sheets is completed (Yes in ACT 207), the reading controller 323 enables the back surface image processing section 324 to execute the image processing in the irregular mode. Specifically, the back surface image processing section 324 executes the sheet position detection processing to generate the back surface position information based on the back surface image data (ACT 208).

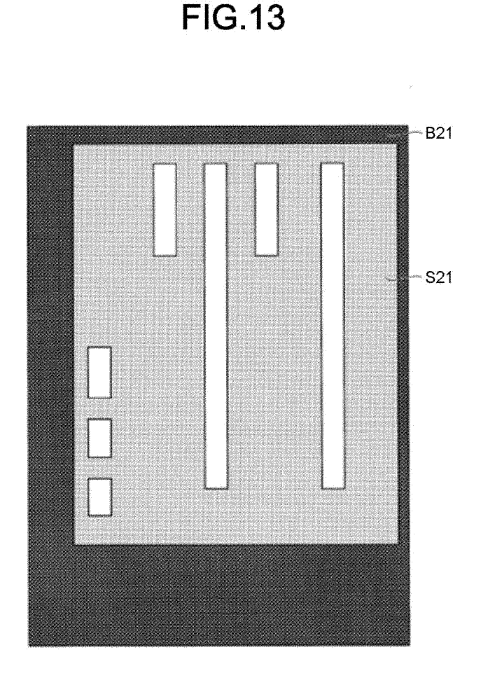

FIG. 12 and FIG. 13 are diagrams of the sheet position detection processing according to the second embodiment. Similar to the front surface image data, the back surface image data includes an image of a background part S21 of the sheet and an image of the member part B21 of the sheet back surface. The back surface image processing section 324 executes the gradation conversion processing using the second LUT for gradation conversion (B) on the back surface image data as a first stage of the sheet position detection processing. FIG. 12 shows a concrete example of the back surface image data subjected to the gradation conversion processing. As shown in FIG. 12, by executing the gradation conversion processing using the second LUT for gradation conversion (B) on the back surface image data, the level difference between the white color of the sheet ground part S11 and the white color of the member part B11 of the sheet back surface is enlarged. By identifying the boundary between the sheet ground and the sheet back surface member that are clarified by enlarging the level difference, the back surface image processing section 324 specifies the sheet position in the back surface image and stores the back surface position information indicating the specified sheet position in the storage section 326.

The back surface image processing section 324 may execute an inversion processing of the brightness on the back surface image data before executing the second gradation conversion processing in advance. FIG. 13 is a diagram illustrating a specific example of the back surface image data on which the inversion processing of the brightness is executed. As shown in FIG. 13, the brightness is inverted beforehand so that the boundary between a sheet ground part S21 and a member part B21 of the sheet back surface becomes clearer in the back surface image data subjected to the second gradation conversion processing, and it becomes possible to more accurately specify the sheet position in the back surface image.

Return to the description of FIG. 11, the front surface image processing section 325 then executes an image cutting processing for cutting the image of the sheet part from the front surface image data based on the back surface position information generated by the back surface image processing section 324 (ACT 209). The front surface image processing section 325 outputs the image data of the sheet front surface cut by the image cutting processing as the reading result of the irregular mode.

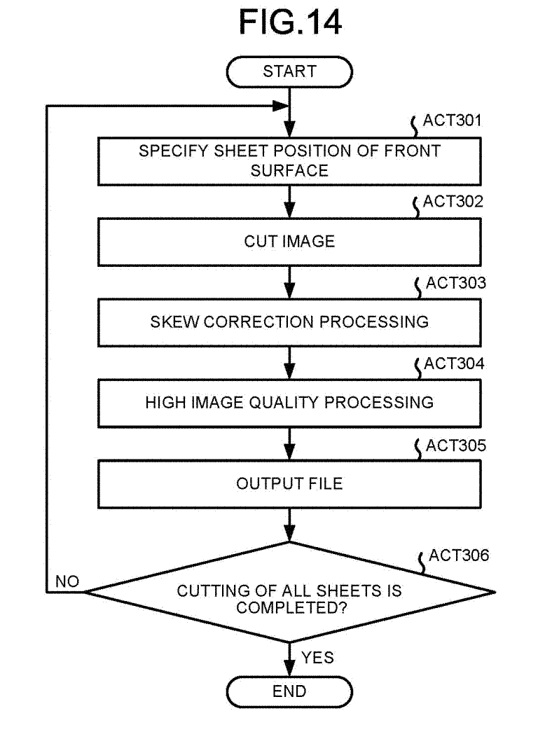

FIG. 14 is a flowchart of the image cutting processing according to the second embodiment. First, the front surface image processing section 325 acquires the back surface position information generated by the back surface image processing section 324 from the storage section 326. The front surface image processing section 325 specifies the sheet position in the front surface image data based on the acquired back surface position information (ACT 301). Since the back surface position information generated by the back surface image processing section 324 indicates the sheet position in the back surface image data, the sheet position in the front surface image data can be specified by inverting the sheet position indicated by the back surface position information in a main scanning direction.

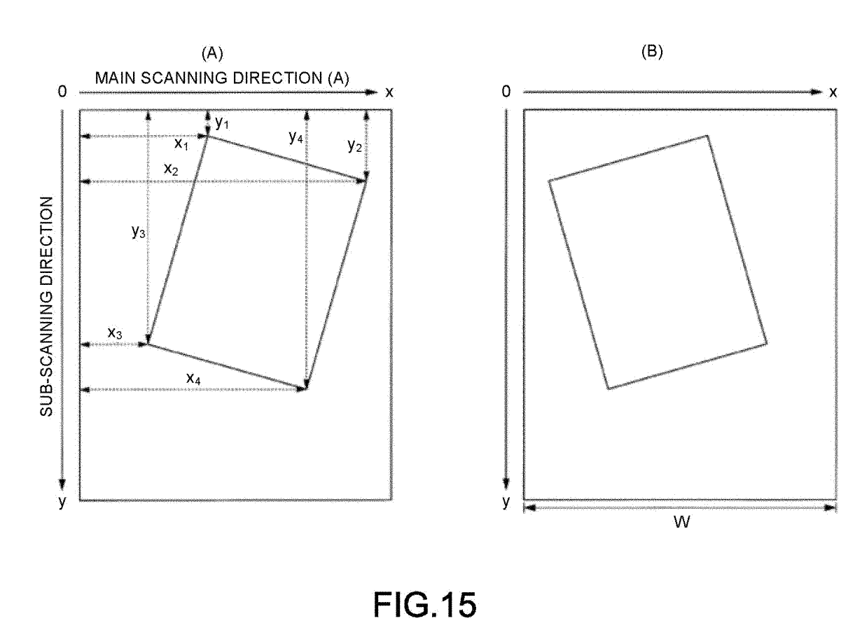

FIG. 15 is a diagram of the relationship between the sheet position in the front surface image data and the sheet position in the back surface image data according to the second embodiment. FIG. 15(A) is a diagram illustrating a specific example of the back surface image data, and FIG. 15(B) is a diagram illustrating a specific example of the front surface image data on the same sheet as that in FIG. 15(A). The numbers attached to the vertical and horizontal axes in FIG. 15(A) and FIG. 15(B) correspond to coordinates of each pixel. An x-axis direction corresponds to the main scanning direction, and a y-axis direction corresponds to a sub-scanning direction. In this case, for example, the back surface position information shows the coordinates of four corners of the sheet in FIG. 15(A). Specifically, the back surface position information shows coordinates (x1, y1) of an upper left corner of the sheet, coordinates (x2, y2) of an upper right corner of the sheet, coordinates (x3, y3) of a lower left corner of the sheet, and coordinates (x4, y4) of a lower right corner of the sheet. In this case, in the back surface image having a position relationship that the back surface image and the front surface image are inverted, the coordinates of the upper left corner of the sheet are (W-x2, y2), the coordinates of the upper right corner of the sheet are (W-x1, y1), the coordinates of the lower left corner of the sheet are (W-x4, y4), and the coordinates of the lower right corner of the sheet are (W-x3, y3). Herein, W represents the number of pixels (width) in the main scanning direction in the image data.

Returning to the explanation of FIG. 14, based on the position information (hereinafter, referred to as “front surface position information”) of the sheet front surface specified as in the example in FIG. 15, the front surface image processing section 325 generates front surface sheet image data obtained by cutting the image of the sheet front surface from the front surface image data held in the page memory PM1 (ACT 302). The skew correction section 327 executes a skew correction processing for correcting the deviation of inclination (generally referred to as “skew”) on the acquired front surface sheet image data (ACT 303). Skew correction may detect the deviation of the inclination from the coordinates of the four corners of the sheet, or detect the deviation of inclination based on content (for example, characters) of the image identified by image analysis.

Subsequently, the high image quality processing section 328 executes a high image quality processing (noise reduction, edge enhancement, etc.) on the front surface sheet image data after the skew correction (ACT 304). The high image quality processing section 328 outputs the front surface sheet image data subjected to the high image quality processing in a predetermined file format (ACT 305). The file may be stored in a storage medium such as the storage section 326 or may be sent to an external device.

The front surface image processing section 325 determines whether or not the image cutting processing is executed on all the front surface image data which is processing object (ACT 306). If there is unprocessed front surface image data (No in ACT 306), the front surface image processing section 325 returns to the processing in ACT 301 and executes the image cutting processing on the unprocessed front surface image data. On the other hand, if the image cutting processing is executed for all the front surface image data (Yes in ACT 306), the front surface image processing section 325 ends the image cutting processing.

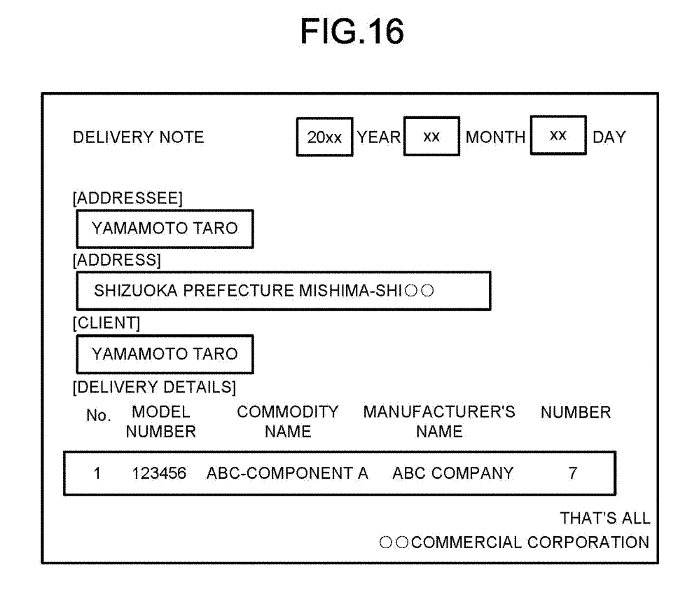

FIG. 16 is a diagram of the image data outputted as the reading result according to the second embodiment. The image forming apparatus 100 of the embodiment constituted in this way reads the sheet back surface if the irregular sheet is read. Then, by executing the gradation conversion processing using the setting information (the LUT for gradation conversion) which is different from normal setting on the read back surface image data, it is possible to enlarge the level difference between the color of the sheet ground and the color of the sheet back surface member and to more precisely specify the sheet position. Therefore, according to the image forming apparatus 100 of the embodiment, it is possible to realize reading of the irregular sheet with a simpler constitution.

In the above embodiment, the multifunction peripheral is exemplified as an example of the image forming apparatus; however, the image forming apparatus of the embodiment may be constructed as a device having only an image reading function.

Further, the reading range in the irregular mode may be any range as long as the sheet which is the reading object is included therein. For example, if a sheet such as a business card or a receipt is assumed, the reading range may be set to a specific range such as A4, B5 and the like which includes those sheets. If a size of the irregular sheet is large, the reading range may be set to a maximum range such as A3. If the image forming apparatus is capable of detecting the size of the sheet as a preprocessing of reading, the image forming apparatus may change the reading range according to the size of the detected sheet.

In reading in the irregular mode, if both of the front and back surfaces of the sheet are reading objects, in addition to the sheet position detection processing, the back surface image processing section 324 may execute a processing similar to the front surface image data on the back surface image data. By executing such processing, the back surface image processing section 324 can deal with duplex reading of the irregular sheet. In this case, the image forming apparatus may have two page memories composed of a page memory for holding the back surface image data for the sheet position detection processing and a page memory for holding the back surface image data for the image cutting processing. The image forming apparatus dealing with the duplex reading of such an irregular sheet may be realized by enabling the back surface image processing section 324 to execute the image cutting processing on the back surface image data, or may be realized by adding a functional section similar to the front surface image processing section 325 as a second back surface image processing section.

The image forming apparatus of an embodiment may read the irregular sheet in conjunction with an external system. For example, the image forming apparatus may send to an expense settlement system requiring image data of a receipt or the like, or to a cloud system that provides similar function. The image forming apparatus may read the irregular sheet according to a request of these external systems.

In accordance with at least one embodiment described above, by comprising the scanner unit (an example of the reading section) which is positioned at the back surface of a sheet which is a reading object, provided with the cover (an example of the back surface part) having a predetermined color at the back surface side of the sheet to read at least one surface of the sheet by using the cover as the background, the second gradation conversion section (an example of the gradation conversion section) which executes the gradation conversion processing of enlarging the level difference in brightness at the highlight side on image data read by the scanner unit, and the controller (an example of the image processing section) which identifies the area of the sheet part and the area of the cover part in the image data based on the image data to which the second gradation conversion processing is executed, it is possible to realize the processing of reading the range including the sheet to be read and identifying the area of the sheet part in the read image data with a simpler arrangement.

In the above embodiment, the first gradation conversion section 314, the second gradation conversion section 315, and the control section 317 are described as individual functional sections; however, either one or both of the first gradation conversion section 314 and the second gradation conversion section 315 may be constituted integrally with the controller 317.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a reading section, positioned at a back surface of a sheet which is a reading object, comprising a back surface part having a predetermined color at a back surface side of the sheet, and configured to read at least one surface of the sheet by using the back surface part as a background;
a gradation conversion section configured to execute a gradation conversion processing of enlarging a level difference in brightness at a highlight side on image data read by the reading section; and
an image processing section configured to identify an area of the sheet part and an area of the back surface part in the image data based on the image data to which the gradation conversion processing is executed.

2. The image forming apparatus according to claim 1, wherein
the image processing section is configured to cut image data in an area identified as the sheet part from image data obtained by reading at least one surface of the sheet and to output the cut image data in a file format.

3. The image forming apparatus according to claim 1, wherein
the reading section is configured to read both surfaces of the sheet, and
the image processing section is configured to execute the gradation conversion processing on image data obtained by reading one surface of the sheet to identify an area of the sheet part in the image data, cut the image data in the area identified as the sheet part from the image data obtained by reading the other surface of the sheet and output the cut image data in a file format.

4. The image forming apparatus according to claim 1, wherein
the image forming apparatus is configured to execute the gradation conversion processing on image data obtained by reading a plurality of aligned sheets to identify each of a plurality of areas of the sheet parts in the image data, cut image data in each area identified for each sheet from the image data and output the cut plural image data in a file format.

5. The image forming apparatus according to claim 1, wherein the image processing section is configured to identify the area of the sheet part and the area of the back surface part including identifying a boundary between the area of the sheet part and the area of the back surface part.

6. The image forming apparatus according to claim 1, wherein the gradation conversion section is configured to execute the gradation conversion processing if a reading mode is an irregular mode used for reading an irregular sheet.

7. The image forming apparatus according to claim 2, further comprising a skew correction section configured to execute skew correction processing on the cut image.

8. An image processing method, including:
reading at least one surface of a sheet by using a back surface part as a background by a reading section positioned at a back surface of the sheet which is a reading object and providing the back surface part having a predetermined color at the back surface side of the sheet;
executing a gradation conversion processing of enlarging a level difference in brightness at a highlight side on image data read by the reading section; and
identifying an area of the sheet part and an area of the back surface part in the image data based on the image data to which the gradation conversion processing is executed.

9. The method according to claim 8, further comprising:
cutting image data in an area identified as the sheet part from image data obtained by reading at least one surface of the sheet and outputting the cut image data in a file format.

10. The method according to claim 8, wherein
the reading comprises reading both surfaces of the sheet, and
executing the gradation conversion processing on image data obtained by reading one surface of the sheet to identify an area of the sheet part in the image data, cutting the image data in the area identified as the sheet part from the image data obtained by reading the other surface of the sheet and outputting the cut image data in a file format.

11. The method according to claim 8, wherein
the gradation conversion processing is executed on image data obtained by reading a plurality of aligned sheets to identify each of a plurality of areas of the sheet parts in the image data, and further comprising cutting image data in each area identified for each sheet from the image data and outputting the cut plural image data in a file format.

12. The method according to claim 8, wherein identifying the area of the sheet part and the area of the back surface part includes identifying a boundary between the area of the sheet part and the area of the back surface part.

13. The method according to claim 8, wherein the gradation conversion processing is executed if a reading mode is an irregular mode used for reading an irregular sheet.

14. The method according to claim 9, further comprising executing skew correction processing on the cut image.

15. An image forming apparatus, comprising:
a reading section, positioned at a back surface of a sheet which is a reading object, comprising a back surface part having a predetermined color at a back surface side of the sheet, and configured to read at least one surface of the sheet by using the back surface part as a background;
a first gradation conversion section configured to execute a first gradation conversion processing of reducing a level difference in brightness at a highlight side on image data read by the reading section;
a second gradation conversion section configured to execute a second gradation conversion processing of enlarging a level difference in brightness at a highlight side on image data read by the reading section; and
an image processing section configured to identify an area of the sheet part and an area of the back surface part in the image data based on the image data to which the second gradation conversion processing is executed, to cut image data subject to the first gradation conversion processing in an area identified as the sheet part from image data obtained by reading at least one surface of the sheet.
